(19) United States
(12) Patent Application Publication
(10) Pub. No.: US 2020/0296943 A1
(43) Pub. Date: Sep. 24, 2020

(54) NET GRIP

(71) Applicant: Samuel I. Mast, Millersburg, OH (US)

(72) Inventor: Samuel I. Mast, Millersburg, OH (US)

(21) Appl. No.: 16/822,653

(22) Filed: Mar. 18, 2020

Related U.S. Application Data
(60) Provisional application No. 62/919,565, filed on Mar. 18, 2019.

(51) Int. Cl. A01K 77/00

(52) U.S. Cl. CPC A01K 77/00

(57) ABSTRACT

A fishing net assembly includes a magnetic clasp system to releasably connect the net to the pole or handle.

### CROSS REFERENCE TO RELATED APPLICATION

This application claims the benefit of U.S. Provisional Patent Application No. 62/919,565, filed Mar. 18, 2019, and which is hereby incorporated by reference in its entirety.

### TECHNICAL FIELD

This disclosure relates to fishing nets used by hook and line fishermen to land a fish.

### BACKGROUND OF THE INVENTION

When trolling or drifting the net of a prior art fishing net will swing out from the net hoop and has a good chance of snagging a hook of the lure used to catch a fish, thereby inhibiting the passage of the net under the fish to land the fish. It would be a significant advance in the art of netting a fish if a system were discovered that solved this and other problems in the use of a fishing net.

### SUMMARY

According to one aspect of the invention, a fishing net assembly includes a pole, a net mounted with respect to the pole, and a magnetic clasp that is configured to releasably retain part of the net with respect to the pole. The magnetic clasp system may include a handle grip attached to the pole or handle of the fishing net and a corresponding net clamp attached to the fishing net. The handle grip and the net clamp comprising magnetic elements so that the net clamp is releasably attracted to the handle grip by magnetic attraction. The magnetic elements may comprise a pair of magnets having opposite north/south polarity or a magnet and an object containing iron.

The above features and advantages and other features and advantages of the present disclosure are readily apparent from the following detailed description of the best modes for carrying out the disclosure when taken in connection with the accompanying drawings

### BRIEF DESCRIPTION OF THE DRAWINGS

FIG. 1 is a schematic, perspective view of a net grip system wherein the net of a pole mounted fishing net is retained by a magnet clasp system comprising a handle grip and a net clamp;

FIG. 2 is a schematic, perspective view of the net grip system shown in FIG. 1 wherein the net clamp is attached to the handle grip by magnetic attraction;

FIG. 3 is a schematic, perspective view of the net grip system shown in FIG. 2 with the net clamp pulled from the handle grip by a force sufficient to overcome the magnetic attraction between the net clamp and the handle grip;

FIG. 4 is a schematic, perspective, exploded view of the net clamp;

FIG. 5 is a schematic, perspective, exploded view of the handle grip; and

FIG. 6 is a schematic, front view of the handle grip.

### DETAILED DESCRIPTION

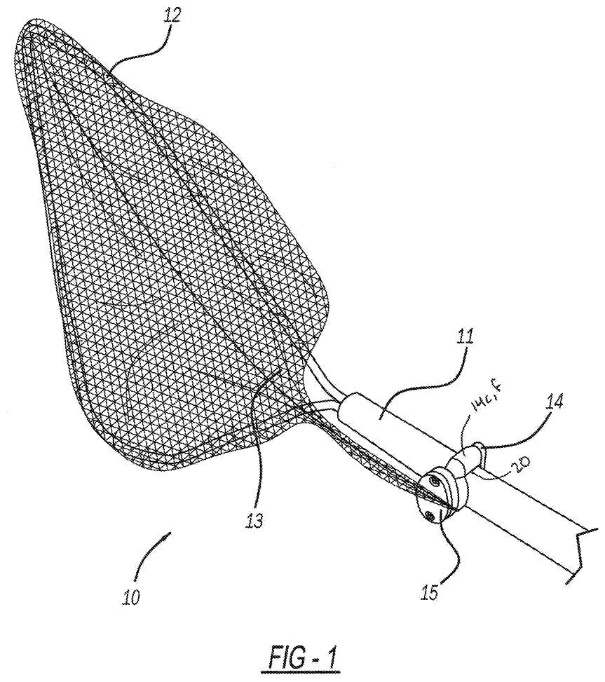

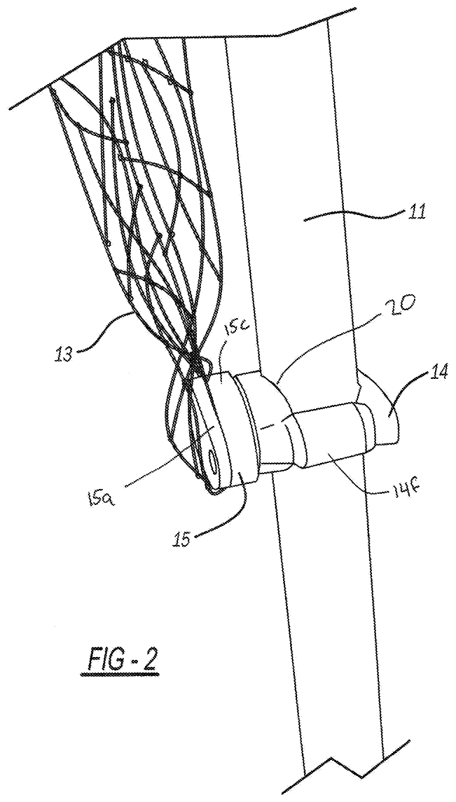

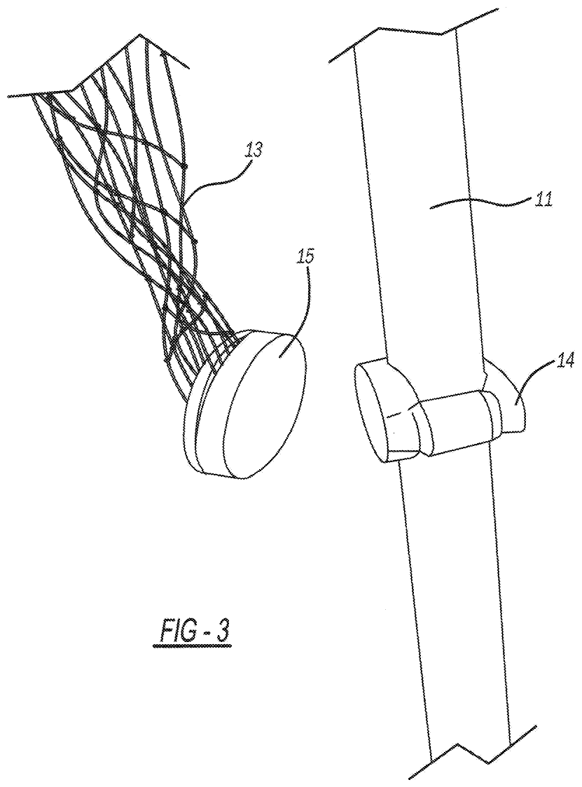

Referring now to FIG. 1, therein is shown a fishing net system 10 including a fishing net assembly having a pole 11, a hoop 12 connected to one end of the pole, and a net 13. The net 13 is attached to the hoop 12 as understood by those skilled in the art. A magnet clasp system includes a handle grip 14 and a net clamp 15. The bottom of net 13 is attached to net clamp 15. Net clamp 15 and handle grip 14 are attracted to each other by a magnetic elements positioned in handle grip 14 and net clamp 15. The term “magnetic elements” refers to, for example and without limitation thereto, a magnet paired with iron or a pair of magnets having opposite north/south orientations so that net clamp 15 is attracted to handle grip 14 as shown in FIGS. 1 and 2. FIG. 3, wherein like reference numbers refer to like components from FIGS. 1 and 2, schematically depicts net clamp 15 pulled from handle grip 14 by a force sufficient to overcome the magnetic attraction between net clamp 15 and handle grip 14.

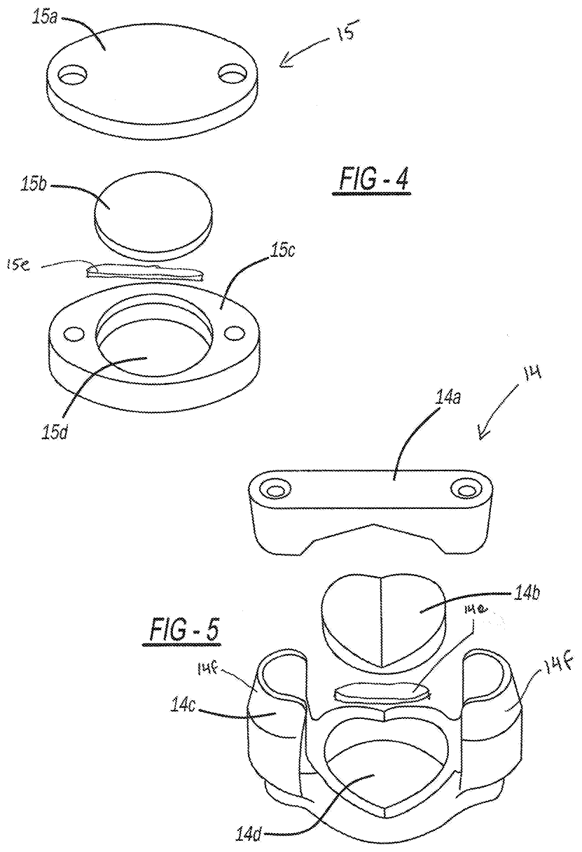

Referring now to FIG. 4, wherein like reference numbers refer to like components from FIGS. 1-3, therein is shown an exploded view of some of the parts of net clamp 15. Net clamp 15 is comprised of net clamp top 15a, net clamp magnet cover 15b, and net clamp magnet holder 15c. Cavity 15d formed in the magnet holder 15c is provided to receive a rare earth coin shaped magnet 15e. The top 15a is affixed to the magnet holder 15c, such as by threaded fasteners (not shown) extending through holes formed in the top 15a and the holder 15c, thereby enclosing the cavity 15d and retaining the magnet 15e and cover 15b therein. The net 13 is attached to the clamp 15 by placing part of the net 13 between the clamp top 15a and the magnet holder 15c; the clamping action of the threaded fasteners will retain the net 13 between the clamp top 15a and the magnet holder 15c, as shown in FIGS. 1-3.

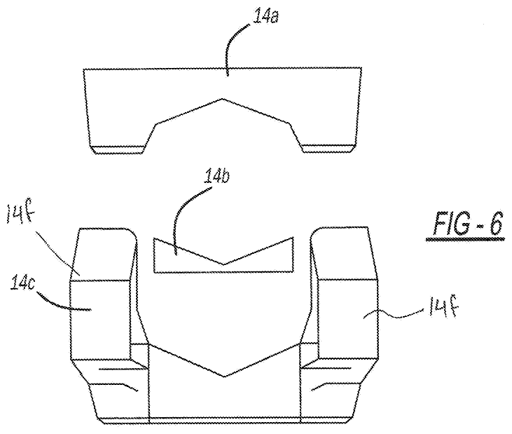

Referring to FIGS. 5 and 6, wherein like reference numbers refer to like components from FIGS. 1-4, handle grip 14 is comprised of net handle clamp 14a, net handle magnet cover 14b and net handle magnet holder 14c. Cavity 14d is provided to receive a rare earth coin shaped magnet 14e having a north/south orientation opposite that of the magnet 15e in cavity 15d so that net clamp 15 is attracted to handle grip 14 by magnetic force. Threaded fasteners extend through holes formed in handle clamp 14a to connect the handle clamp 14a to the magnet holder 14c. Magnet holder 14c includes two protruding arms 14f When the clamp 14a is connected to the holder 14c, the arms 14f, the clamp 14a, and the portion of the magnet holder 14c defining cavity 14d define a passageway 20 through which the pole 11 extends, thereby securing the handle grip 14, along with magnet 14e, to the pole 11.

In use, the net clamp 15, with a portion of the net 13 attached thereto, is connected to the handle grip 14 by the attraction between the magnetic elements 14e, 15e. More specifically, in the embodiment depicted, the magnetic attraction between the magnetic elements 14e, 15e keeps the magnet holder 15c in contact with the other magnet holder 14c. thereby retaining the net 13 in the position shown in FIG. 1. When used by a hook and line fisherman to retrieve a fish from the water, the net 13 is passed through the water toward the fish to capture the fish in the net 13 and to cause the net clamp 15 to release from the handle grip 14 by the weight of the fish in the net 13. Without the net grip system of the instant invention, when trolling or drifting the net 13 will swing out from the net hoop 12 and has a good chance of snagging a hook of the lure used to catch a fish thereby inhibiting the passage of the net 13 under the fish to land the fish. If the fish is small or less than legal size, the magnetic elements of the instant invention will not release from the handle grip but can be shaken or bumped to release whereupon the fish will drop into the net.

The components of the instant invention can be made of any suitable material. However, the components shown in FIGS. 4-6 are preferably made of a plastic material and can be injection molded from a thermoplastic resin. It should also be noted that the various components that form the clamp 15 may be integrally formed and combined within the scope of the claimed invention. For example, the magnet 15e may be molded into the magnet holder 15c, thereby eliminating the need for cover 15b. Similarly, the various components that form the handle grip 14 may be integrally formed and combined within the scope of the claimed invention. The clamp 15 may use other techniques for attachment to the net 13 within the scope of the claimed invention.

While the best modes for carrying out the disclosure have been described in detail, those familiar with the art to which this disclosure relates will recognize various alternative designs and embodiments for practicing the disclosure within the scope of the appended claims.

1. A fishing net system comprising:
a fishing net assembly having a pole and a net mounted with respect to the pole; and
a magnetic clasp system having a first magnetic element mounted to the pole and a second magnetic element mounted to the net.

2. The fishing net system of claim 1, wherein the magnetic clasp system includes a handle grip attached to the pole and a corresponding net clamp attached to the fishing net;
wherein said first magnetic element is mounted to the handle grip and the second magnetic element is mounted to the net clamp.

3. The fishing net system of claim 2, wherein the magnetic elements comprise a pair of magnets having opposite north/south polarity.

4. The fishing net system of claim 2, wherein the magnetic elements comprise a magnet and an object containing iron.

5. A magnetic clasp system for use with a fishing net assembly having a net and a pole, the clasp system comprising:
a handle grip mountable to the pole and having a first magnetic element connected thereto; and
a net clamp being connectable to the net and having a second magnetic element connected thereto;
said first magnetic element having a magnetic attraction to the second magnetic element sufficient to retain the net clamp adjacent to the handle grip.

6. A method for use with a fishing net assembly having a pole and a net operatively connected to the pole, the method comprising:
retaining part of the net in a position relative to the pole using magnetic attraction.

7. The method of claim 6, wherein a first magnetic element is operatively connected to the pole and a second magnetic element is operatively connected to the net; and
wherein said retaining part of the net in a position relative to the pole using magnetic attraction includes positioning the second magnetic element relative to the first magnetic element such that the magnetic force between the first and second magnetic elements is sufficient to retain the part of the net relative to the pole.
